(19) United States
(12) Patent Application Publication
(10) Pub. No.: US 2017/0279769 A1
(43) Pub. Date: Sep. 28, 2017

(54) AUTOMATED CREATION AND USE OF VPN CONFIGURATION PROFILES

(71) Applicant: Fortinet, Inc., Sunnyvale, CA (US)

(72) Inventor: Jonathan D. Jachniuk, Modi'in-Maccabim-Re'ut (IL)

(73) Assignee: Fortinet, Inc., Sunnyvale, CA (US)

(21) Appl. No.: 15/078,324

(22) Filed: Mar. 23, 2016

(51) Int. Cl. H04L 29/06; G06K 7/10; H04L 12/24; H04L 12/58; H04L 12/46; H04L 29/08

(52) U.S. Cl. CPC H04L 63/0227; H04L 12/4641; H04L 67/30; H04L 41/0806; H04L 51/04; H04L 63/0428; H04L 63/06; G06K 7/10722

(57) ABSTRACT

Systems and methods for automatically obtaining virtual private network (VPN) connection profile data from a barcode are provided. According to one embodiment, a client security application obtains a barcode, wherein the client security application is installed on a client machine and is used for managing the security of the client machine. The client security application identifies a configuration profile of a virtual private network (VPN) that is encoded by the barcode and creates the configuration profile of the VPN at the client machine.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright©2016, Fortinet, Inc.

### BACKGROUND

Field

Embodiments of the present invention generally relate to the field of network security techniques. In particular, various embodiments relate to methods for establishing a virtual private network (VPN) connection by scanning a barcode.

Description of the Related Art

Enterprise customers are now demanding cost-effective, outsourced connectivity and security services, such as Virtual Private Networks (VPNs). A VPN is a private network that takes advantage of a public telecommunication network (e.g., the Internet) and maintains privacy through use of tunneling protocols and security procedures. Current VPN setup procedures are complicated, requiring network administrators as well as the end users to perform extensive manual configurations on both peers of the VPN connection before the VPN can be used. The parameters for setting up a VPN connection at the client side may include one or more of: VPN type (e.g., Secure Sockets Layer (SSL)-VPN or Internet Protocol Security (IPsec) VPN), connection name, description, VPN gateway address, port number and user authentication information. One or more VPN configuration profiles may be created at the client machine to store these VPN parameters. The client user may select a VPN configuration profile and launch a corresponding VPN connection. The procedure to configure a VPN can be complicated and fallible because many parameters are involved, shared and must match on both sides of the connection. Therefore, there is a need for a simplified way to establish and manage VPN connection profiles and launch VPN connections by client devices.

### SUMMARY

Systems and methods are described for automatically obtaining virtual private network (VPN) connection profile data from a barcode. According to one embodiment, a client security application obtains a barcode, wherein the client security application is installed on a client machine and is used for managing the security of the client machine. The client security application identifies a configuration profile of a virtual private network (VPN) that is encoded by the barcode and creates the configuration profile of the VPN at the client machine.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating an exemplary network architecture in which embodiments of the present invention may be employed.

FIG. 2 is a flow diagram illustrating automated creation of a VPN configuration profile and launching of a VPN connection in accordance with an embodiment of the present invention.

FIG. 3 illustrates a graphical user interface (GUI) screen shot, which may be used to create a new VPN configuration profile at a client machine, in accordance with an embodiment of the present invention.

FIGS. 4A and 4B illustrate exemplary barcodes with encoded VPN configuration profiles in accordance with embodiments of the present invention.

FIG. 5 illustrates a graphical user interface screen shot, which may be used to setup a new VPN configuration profile at a client machine, in accordance with an embodiment of the present invention.

FIG. 6 is a block diagram illustrating functional units of a client security application in accordance with an embodiment of the present invention.

FIG. 7 is an exemplary computer system in which or with which embodiments of the present invention may be utilized.

### DETAILED DESCRIPTION

Systems and methods are described for automatically obtaining virtual private network (VPN) connection profile data from a barcode. According to one embodiment, a client security application obtains a barcode, wherein the client security application is installed on a client machine and is used for managing the security of the client machine. The client security application identifies a configuration profile of a virtual private network (VPN) that is encoded by the barcode and creates the configuration profile of the VPN at the client machine.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

As used herein, the term “barcode” broadly refers to any optical machine-readable representation of data. Data was originally represented in barcodes (referred to as linear or one-dimensional (1D)) by varying the widths and spacing of parallel lines. Barcodes later evolved into rectangles, dots, hexagons and other geometric patterns in two dimensions (2D). Although 2D systems use a variety of symbols, they are generally referred to as barcodes as well. As used herein the term “barcode” is intended to encompass existing and future types of barcodes, including, but not limited to 1D barcodes, matrix (2D) barcodes, numeric-only barcodes, alphanumeric barcodes and the following non-limiting symbologies: Codabar, Code 24, Code 11, Farmacode, Code 32, Code 39, Code 49, Code 93, Code 128, CPC Binary, European Article Numbering System (EAN) 2, EAN 5, EAN-8, EAN-13, GS1-128, DS1 DataBar, Interleaved 2 of 5 (ITF)-14, JAN, MSI, Pharmacode, Postal Numeric Encoding Technique (POSTNET), Telepen, Universal Product Code (UPC), Aztec Code, Code 1, Data Matrix, EZcode, MaxiCode, PDF417, Qode, QR code and SPARQCode.

The phrase “client device” generally refers to a computing device that may access resources through a network connection. A client device may be an endpoint device located at or near the edge of a network and is capable of running one or more applications for a single user. Examples of client devices include, but are not limited to, desktop or laptop personal computers (PCs), handheld computers, tablets and smart phones.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

If the specification states a component or feature “may”, “can”, “could”, or “might” be included or have a characteristic, that particular component or feature is not required to be included or have the characteristic.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, Layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

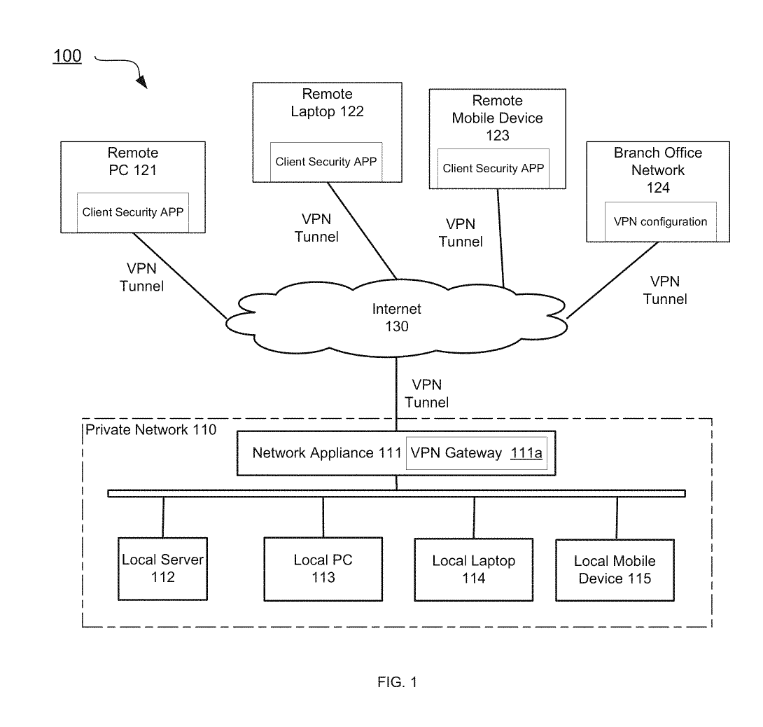

FIG. 1 illustrates an exemplary network architecture in accordance with an embodiment of the present invention. In accordance with the present example, network architecture 100 includes a private network 110 which is connected to the Internet 130. Private network 110 includes multiple network appliances, such as a local server 112, a local PC 113, a local laptop 114, a local mobile phone 115 and other computing devices that are operatively coupled to each other through a Local Area Network (LAN), wherein the LAN is then operatively coupled with network appliance 111 which enables access to Internet 130. Other network appliances, such as a remote PC 121, a remote PC 122, a remote mobile device 123 and a branch office network 124 may connect to private network 110 from outside through Internet 130.

Network appliance 111 separates the external computing environment, represented by Internet 130, from the internal computing environment of private network 110. Network appliance 111 may intercept communications between Internet 130 and the network appliances of private network 110 and may, among other things, scan for malware, viruses or high risk network accesses. Network appliance 111 may include a VPN gateway 111a, representing a connection point that connects remote client machines (such as, remote PC 121, remote laptop 122, and remote mobile device 123) or remote LANs (such as, branch office network 124) to private network 110 through secure tunnels over a non-secure network such as the Internet 130. VPN gateway 110a can encrypt packets between private network 110 and remote network appliances on the fly, making it safe for them to traverse the Internet 130.

In order to establish VPN connections with remote network appliances, the administrator of private network 110 may setup a VPN configuration profile for VPN gateway 111a. The configuration profile may include various security parameters (e.g., VPN types that are supported by VPN gateway 111a, a gateway IP address, a port number and user authentication information). Several network firewall objects and policies may be manually established by the network administrator within network appliance 111 and VPN gateway 111a. In the present example, a barcode containing data indicative of the VPN configuration profile may be generated by network appliance 111 or VPN gateway 111a. While the embodiments described herein may refer to specific types of barcodes, no specific type of barcode is required to implement the functionality described herein. The barcode may be a linear barcode or a matrix barcode that has the capacity to encode all the data associated with the VPN configuration profile. Further, if authentication information (e.g., a password and/or username) is contained in the VPN configuration profile, the profile data may be encrypted by an encryption key to limit use of the profile data to a client security application, for example, that has the corresponding decryption key so as to protect the profile against unauthorized use. The barcode may be displayed or printed out for scanning by an optical barcode reader, a smartphone barcode scanner application (e.g., Scan 2.0, Barcode Scanner, NeoReader) or the like or captured in the form of a digital photograph and sent to client security applications running on remote network appliances through a communication tool, including, but not limited to, electronic mail (Email), multimedia message service (MMS), file transfer protocol (FTP) and instant messenger.

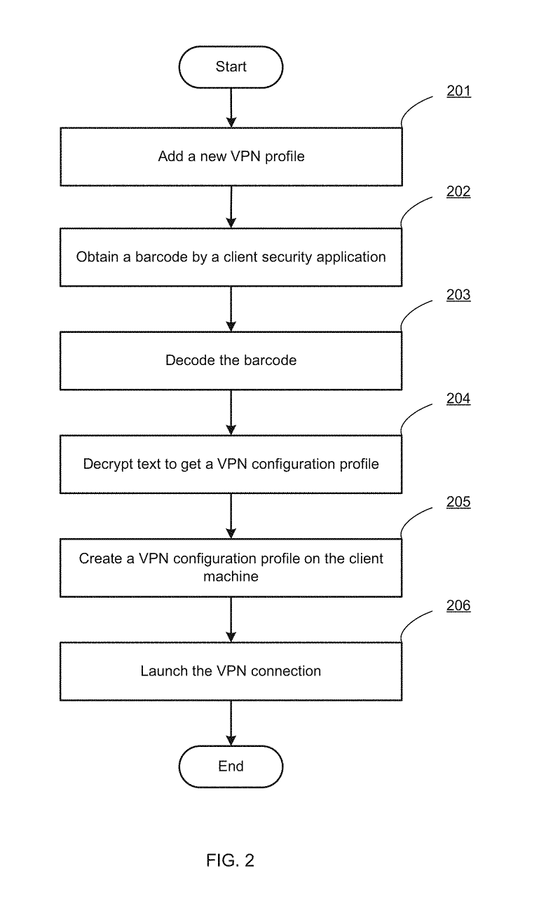

A client security application (e.g., the FORTICLIENT family of endpoint protection applications) may be installed on each of the remote client devices (e.g., remote PC 121, remote laptop 122, and remote mobile device 123). The client security application may include multiple engines that provide security functions (e.g., anti-virus, web filtering, application firewalling, two-factor authentication, vulnerability scanning and Wide Area Network (WAN) optimization). In the present example, the client security application may also establish a Secure Sockets Layer (SSL)/Internet Protocol Security (IPSec) VPN tunnel between the client device and VPN gateway 111a of private network 110. The client security application may create one or more VPN connection profiles at the client device. One of the VPN connection profiles contains parameters that are used for establishing a VPN tunnel with VPN gateway 111a. When the user of the client device wants to establish a VPN connection to a private network, a corresponding VPN configuration profile may be selected. The client security application may use the selected VPN configuration profile and launch the VPN connection with the VPN gateway of the private network using the parameters in the selected VPN configuration profile. A VPN configuration profile of a client device may be manually created by the end user of the client device by inputting the necessary parameters through a graphical user interface screen. In accordance with embodiments of the present invention, however, a VPN configuration profile is created automatically by scanning a barcode generated by a VPN gateway without requiring manual input of the parameters. For example, a barcode image file that contains parameters for establishing a VPN connection with a private network may be provided to the client security application by VPN gateway via Email, MIMS or the like. The parameters may then be decoded from the barcode image file by a barcode decoder implemented within the client security application. The parameters may be stored automatically as a new VPN configuration profile at the client device by the client security application. Then, a VPN connection may be launched by the client security application based on parameters of the VPN configuration profile created from the barcode. A process of managing VPN configuration profiles will be described further below with reference to FIG. 2.

FIG. 2 is a flow diagram illustrating automated creation of a VPN configuration profile and launching of a VPN connection in accordance with an embodiment of the present invention.

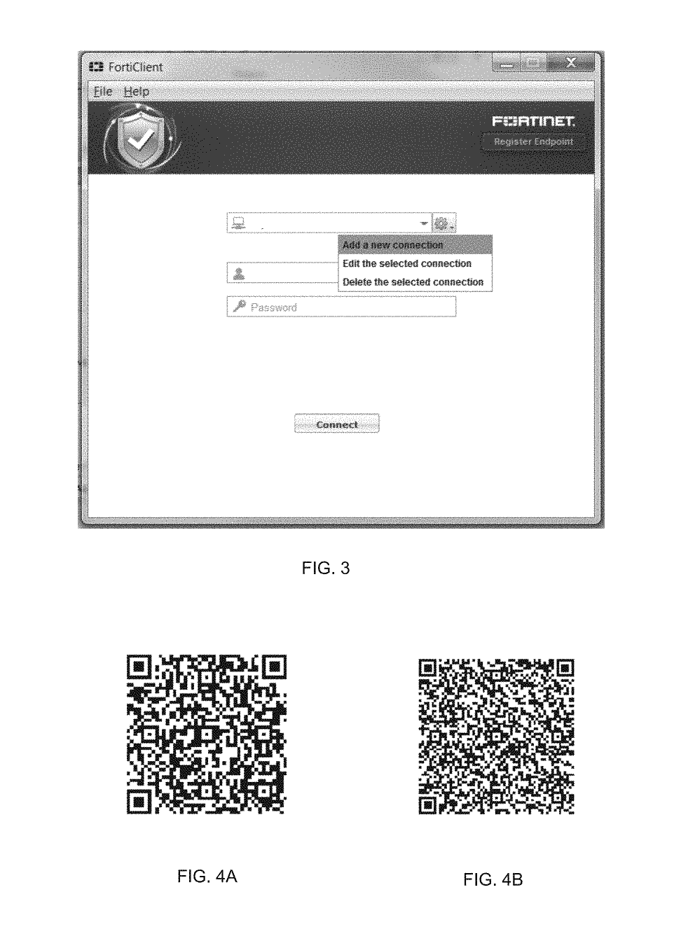

At block 201, a user of a client device adds a new VPN configuration profile to a client security application. FIG. 3 shows an example of a VPN profile management dialog of a client security application. The user may start a process of adding a new VPN profile by selecting an “Add a new connection” option of the GUI.

At block 202, the client security application may obtain a barcode that contains data representative of parameters of a VPN configuration profile. In one example, the client security application may scan a barcode with an optical barcode reader or a camera associated with, connected to or integrated within the client device. In another example, the client security application may receive a media file that contains the barcode through a communication tool. An example of a barcode containing VPN configuration profile data is shown in FIGS. 4A and 4B.

At block 203, the client security application decodes the barcode by a barcode decoder. The barcode may be a linear barcode or a matrix barcode. No specific type of barcode is required. A corresponding barcode decoder may be called by client security application in order to decode the data encoded within the barcode. For example, the text decoded from the barcode shown in FIG. 4A represent a VPN configuration profile as follows:
VPN TYPE: SSL-VPN
Connection Name: Fortinet_vpn
Description: Fortinet_vpn
Remote Gateway: vpn.fortinet.com
Authentication: Save login
Username: User1

At block 204, if the data encoded within the barcode is encrypted, the client security application may further decrypt the data extracted (decoded) from the barcode. For example, FIG. 4B shows a barcode that contains encrypted VPN configuration profile data as shown above. The encrypted text decoded from the barcode is as follows:

rzflIFldYsMRNovMF9Gs3Jh7A3wrjNM0LEnLGX4hMTEhQ+AQITkhpu
OVl+XCwbbT8XH6eB1Vwxd7Ae6v/U5e4XLIF2azXZ/nF4saOYSvSp5n
bWt6zFXDF3sB7q/9Tl7hcsgXZrO1Ghu/0T7Q9FQyhQgzY8Pb2VM6tY
NJZden0bKlCEIOs5PHO3pcp5J2LimnaCEzOSEsvYXuTkhHRvLXYnUR
ITE2MCE2B5vvVt1Izsr8j4c04Xy87+lQWohwITExIYYSK1yxIyExMy
EX6Da7+VXM

The client security application may decrypt the encrypted text using the encryption key to obtain the corresponding plain text as shown above. In one example, when the client security application is registered with the VPN gateway, the encryption key may be transferred to the client security application from the VPN gateway through a physical (e.g., cable) connection or other secure connection. In another example, the encryption key may be obtained by the client security application through a separate channel or may be manually input by the user of the client security application.

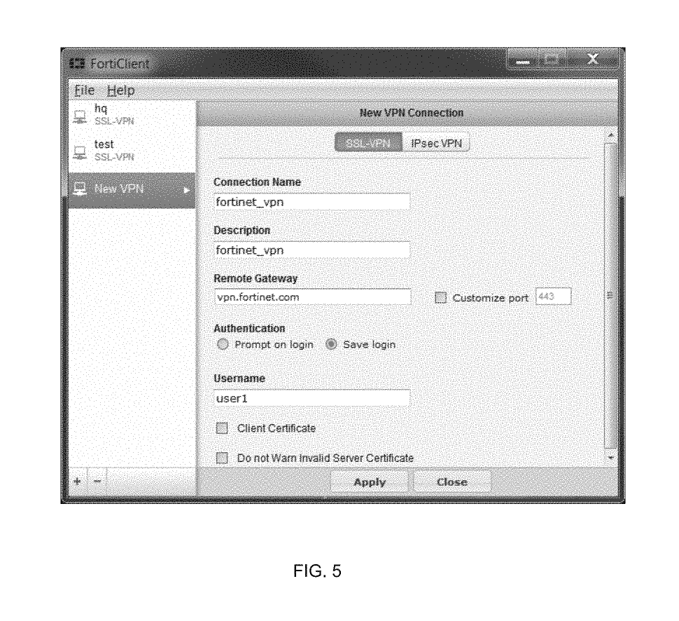

At block 205, responsive to receipt and processing of the barcode, the client security application may create a new VPN configuration profile and store the parameters obtained from the barcode within the client device in a VPN profile repository within the client security application, for example. An example of newly created VPN configuration profile is shown in FIG. 5. In this example, all required the parameters of the VPN configuration profile are automatically obtained from the barcode without requiring manual input.

At block 206, the client security application may further launch a VPN connection with the private network based on the newly created VPN configuration profile. The process of establishing a VPN tunnel with a private network is well-known to those skilled in the art and hence further description thereof will be omitted for brevity.

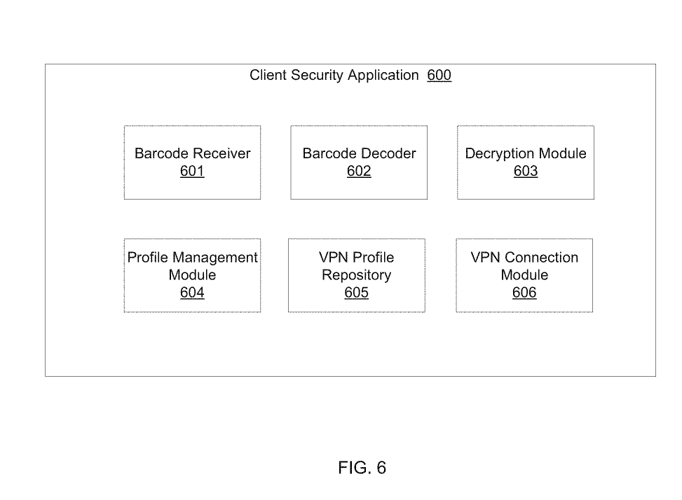

FIG. 6 is a block diagram illustrating various functional units of a client security application 600 in accordance with an embodiment of the present invention. Client security application 600 is installed on a client device and may include a barcode receiver 601, a barcode decoder 602, a decryption module 603, a profile management module 604, a VPN profile repository 605 and a VPN connection module 606.

In one example, barcode receiver 601 may be a camera that is integrated with the client device or an optical barcode reader that is connected to the client device through a Universal Serial Bus (USB) interface, for example. Barcode data may be obtained by scanning a barcode that is displayed on a screen or printed on a physical media (e.g., paper) by the camera or by the optical barcode reader. In other examples, barcode receiver 601 may include a network communication tool that can receive an image file of a barcode from a remote network.

Barcode decoder 602 is used for decoding the barcode obtained by barcode receiver 601 and recognizing the text encoded in the barcode. Barcode decoder 602 may include one or more decoder engines to decode different types of barcodes.

Decryption module 603 is used for decrypting cipher text to plain text if the barcode contains encrypted VPN configuration profile data. The encryption key may be received by decryption module 603 when client security application 600 is initially registered with the VPN gateway or may be input by the user of the client device upon which client security application 600 is running.

Profile management module 604 is used for managing VPN configuration profiles within client security application 600. After the text of VPN configuration profile is obtained from the barcode, a new VPN configuration profile may be created by profile management module 604. The new VPN configuration profile may be stored within VPN profile repository 605. If the VPN configuration profile obtained from the barcode already exists within VPN profile repository 605 and parameters obtained from the barcode are different, VPN profile repository 605 may be updated in accordance with the barcode.

VPN connection module 606 is used for launching a VPN connection based on a VPN configuration profile obtained from the barcode. VPN connection module 606 may start a process of establishing a VPN tunnel with a gateway designated in the VPN configuration profile and using the authentication information designated in the VPN configuration profile to authenticate client security application 600. The process of starting a VPN tunnel is well-known to those skilled in the art. As such, further description will be omitted for sake of brevity.

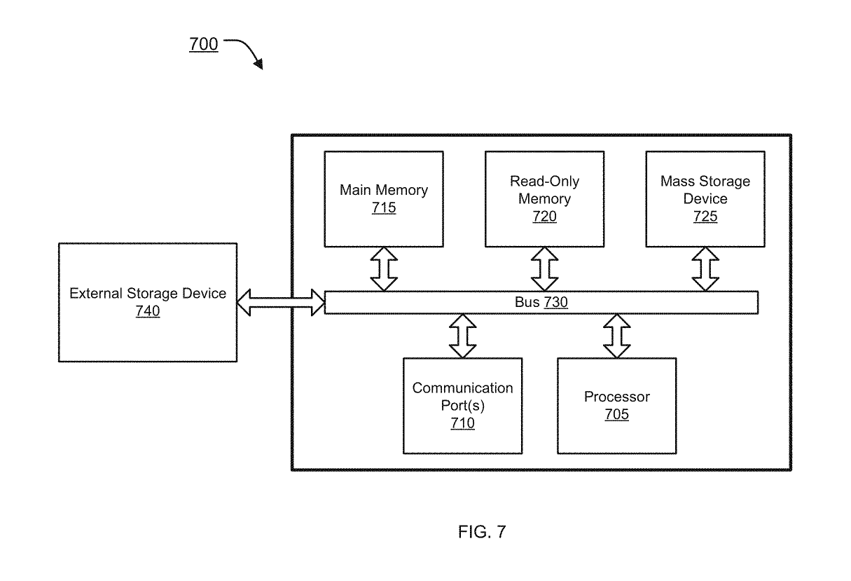

FIG. 7 is an example of a computer system 700 with which embodiments of the present disclosure may be utilized. Computer system 700 may represent or form a part of a network appliance (e.g., network appliance 111), a client device (e.g., remote PC 121, remote laptop 122 or remote mobile device 123), a VPN gateway (e.g., VPN gateway 111a), a server or a client workstation.

Embodiments of the present disclosure include various steps, which will have been described in detail above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 700 includes a bus 730, a processor 705, communication port 710, a main memory 715, a removable storage media 740, a read only memory 720 and a mass storage 725. A person skilled in the art will appreciate that computer system 700 may include more than one processor and communication ports.

Examples of processor 705 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 705 may include various modules associated with embodiments of the present invention.

Communication port 710 can be any of an RS-232 port for use with a modem based dialup connection, a 10/100 Ethernet port, a Gigabit or 10 Gigabit port using copper or fiber, a serial port, a parallel port, or other existing or future ports. Communication port 710 may be chosen depending on a network, such a Local Area Network (LAN), Wide Area Network (WAN), or any network to which computer system 700 connects.

Memory 715 can be Random Access Memory (RAM), or any other dynamic storage device commonly known in the art. Read only memory 720 can be any static storage device(s) such as, but not limited to, a Programmable Read Only Memory (PROM) chips for storing static information such as start-up or BIOS instructions for processor 705.

Mass storage 725 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 730 communicatively couples processor(s) 705 with the other memory, storage and communication blocks. Bus 730 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 705 to system memory.

Optionally, operator and administrative interfaces, such as a display, keyboard, and a cursor control device, may also be coupled to bus 730 to support direct operator interaction with computer system 700. Other operator and administrative interfaces can be provided through network connections connected through communication port 710.

Removable storage media 740 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

What is claimed is:

1. A method comprising:
obtaining, by a client security application running on a client device and managing the security of the client device, a barcode;
extracting, by the client security application, data representing a configuration profile of a virtual private network (VPN) that is encoded within the barcode;
creating, by the client security application, a new VPN configuration profile within the client device based on the extracted data.

2. The method of claim 1, further comprising responsive to creation of the new VPN configuration profile, establishing, by the client security application, a VPN connection with a VPN gateway of a private network with which the client security application is registered.

3. The method of claim 1, wherein the barcode comprises a linear barcode or a matrix barcode.

4. The method of claim 1, wherein the data is encrypted.

5. The method of claim 4, further comprising decrypting, by the client security application, the encrypted data.

6. The method of claim 1, wherein said obtaining, by a client security application, a barcode comprises causing, by the client security application, the barcode to be scanned by a camera or an optical barcode reader of the client device.

7. The method of claim 1, wherein said obtaining, by a client security application, a barcode further comprises receiving, by the client security application, an image of the barcode through a communication tool.

8. The method of claim 7, wherein the communication tool comprises electronic mail (Email), multimedia message service (MMS), file transfer protocol (FTP) or an instant messenger application.

9. The method of claim 1, wherein the configuration profile comprises information indicative of a VPN type, a remote gateway address, a port number and user authentication information.

10. The method of claim 1, further comprising storing, by the client security application, the configuration profile within a VPN profile repository of the client security application.

11. A computer system comprising:
a non-transitory storage device having embodied therein instructions representing a client security application; and
one or more processors coupled to the non-transitory storage device and operable to execute the client security application to perform a method comprising:
obtaining a barcode, wherein the client security application is installed on the computer system and is used for managing the security of the computer system;
extracting data representing a configuration profile of a virtual private network (VPN) that is encoded within the barcode; and
creating a new VPN configuration profile within the computer system based on the extracted data.

12. The computer system of claim 11, wherein the method further comprises responsive to creation of the new VPN configuration profile, establishing a VPN connection with a VPN gateway of a private network with which the client security application is registered.

13. The computer system of claim 11, wherein the barcode comprises a linear barcode or a matrix barcode.

14. The computer system of claim 11, wherein the data is encrypted.

15. The computer system of claim 14, wherein the method further comprises decrypting the encrypted data.

16. The computer system of claim 11, wherein said obtaining a barcode comprises causing the barcode to be scanned by a camera or an optical barcode reader of the computer system.

17. The computer system of claim 11, wherein said obtaining a barcode comprises receiving an image of the barcode through a communication tool.

18. The computer system of claim 17, wherein the communication tool comprises electronic mail (Email), multimedia message service (MMS), file transfer protocol (FTP) or an instant messenger application.

19. The computer system of claim 11, wherein the configuration profile comprises information indicative of a VPN type, a remote gateway address, a port number and user authentication information.

20. The computer system of claim 11, wherein the method comprises storing the configuration profile at a VPN profile repository of the client machine.
